(19) United States
(12) Patent Application Publication
(10) Pub. No.: US 2008/0157029 A1
(43) Pub. Date: Jul. 3, 2008

(54) Method of producing copper nanoparticles and copper nanoparticles produced thereby

(75) Inventors: Young-II Lee, Anyang-si (KR); Young-Soo Oh, Seongnam-si (KR); Jae-Woo Joung, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/785,095

(22) Filed: Apr. 13, 2007

(30) Foreign Application Priority Data
Jul. 10, 2006 (KR) 10-2006-0064501

(51) Int. Cl. H01B 1/02; C22C 9/00; B22F 9/16; B32B 15/02

(52) U.S. Cl. 252/512; 420/469; 977/773; 977/810; 75/370

(57) ABSTRACT

The present invention relates to a method of producing copper nanoparticles, in particular to, a method of producing copper nanoparticles, including: preparing a first solution including a polar solvent, a dispersing agent and one or more reducing agents selected from the group consisting of sodium hypophosphates(NaH₂PO₂), hydrazine(N₂H₄), hydrochloride and sodium borohydride(NaBH₄) and heating the solution; preparing a second solution including a polar solvent and a copper precursor and heating the solution; and injecting the heated second solution into the heated first solution at a time and mixing each other. According to the present invention, copper nanoparticles which are fine and uniform can be produced simply, and thus the method is useful in mass production of copper nanoparticles.

### CROSS-REFERENCE TO RELATED APPLICATIONS

This application claims the benefit of Korean Patent Application No. 2006-0064501 filed on Jul. 10, 2006, the contents of which are incorporated here by reference in their entirety.

### BACKGROUND

1. Technical Field

The present invention relates to a method of producing copper nanoparticles having a uniform particle size and an excellent dispersibility from copper ions in an aqueous solution.

2. Description of the Related Art

Recently, demands for a metal patterning of a thin film through ink jet or microwiring formation on a substrate have been increased according to a tendency of miniaturization and high densification of electronic parts.

In order to implement this, it is required that a conductive ink should be made from copper particles of nano-size which shows an excellent dispersibility, a uniform shape and a narrow distribution of particles.

There are various conventional methods of producing metal nanoparticles, such as mechanical grinding method, co-precipitation method, spray, sol-gel method, electrodeposition and micro emulsion method. However, it is impossible to control size, shape and size distribution of particles in the co-precipitation method. Also, it is difficult to produce metal particles in mass production and production cost is high in the electrodeposition and sol-gel methods. In micro emulsion method, the size, shape and size distribution of particles produced are easy to control, but it is not suitable for practical use since the manufacturing process is complicated.

Recently, a try to manufacture copper micro-powder using the wet reduction process has been made. Here, a partial reduction method using hydrazine was particularly provided as a proper means for manufacturing copper particles having a particle size of about 0.1-100 μm.

Japanese patent publication No. 1990-294414 provided a method of producing copper particles including adding an alkali hydroxide and a reducing sugar to a copper salt solution under the presence of one or more compounds selected from the group consisting of amino acid, the salts thereof, ammonia, ammonium salts, organic amine and dimethyl glyoxime; and precipitating the cuprous oxide particles; and subsequently reducing the copper oxide particles with hydrazine.

In addition, Korean Patent publication No. 2005-3169 provided a method of producing copper particles, comprising making an aqueous solution of copper salt complex by mixing an aqueous solution of a copper salt with ammonia solution; and reducing the aqueous solution of copper salt complex with ascorbic acid to make copper powder, wherein surfactant is added to control the nucleus size and growth of a copper particle for producing copper particles of 0.3-4 μm.

Further, Korean Patent Publication No. 2004-37824 provided a method of producing ultra fine copper powder including adding NaOH and hydrazine appropriately to aqueous solution of copper chloride to make intermediate and complex; and making finally copper particles of about 100 nm by wet reduction process.

Copper particles produced according to the methods provided by the mentioned above were characterized by a feature that the distribution of a particle size is to be small or the particle size is to be uniform, but eventually they have shown wide distribution of particle size due to difficulties in controlling the nucleation and growth of copper particles. Moreover, they neither provided a method of producing small and uniform particles of less than 100 nm, nor solved various problems in mass production of particles economically.

### SUMMARY

The present invention provides a method of producing copper nanoparticles having a narrow distribution of particle size and an excellent dispersibility by employing an appropriate dispersing agent and a reducing agent in the conventional wet reduction process.

Also, the present invention provides copper nanoparticles produced by the method.

Further, the present invention provides conductive ink including copper nanoparticles produced by the method.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a photograph representing powder of copper nanoparticles produced according to an embodiment of the invention.

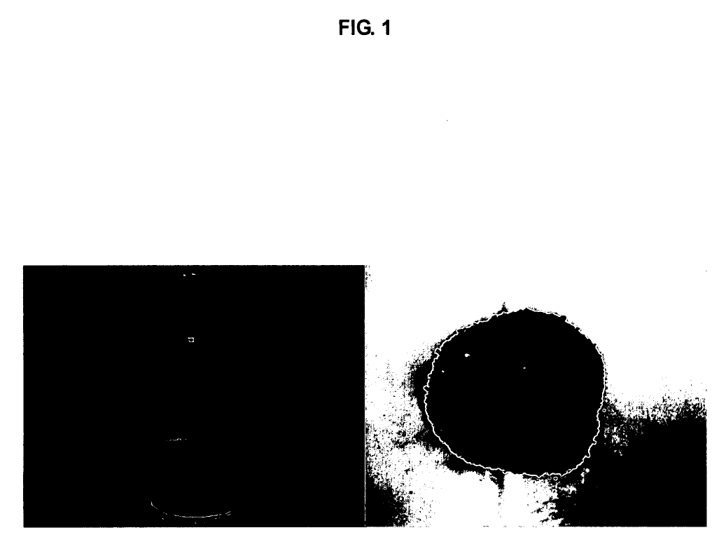

FIG. 2a is a TEM image of copper nanoparticles produced according to an embodiment of the invention.

FIG. 2b is a SEM image of copper nanoparticles produced according to an embodiment of the invention.

FIG. 3 is a graph representing XRD analysis of copper nanoparticles produced according to an embodiment of the invention.

FIG. 4 is a graph representing TGA analysis of copper nanoparticles produced according to an embodiment of the invention.

### DETAILED DESCRIPTION

One aspect of the present invention may provide a method of producing copper nanoparticles, comprising:

preparing a first solution including a polar solvent, a dispersing agent and one or more reducing agents selected from the group consisting of sodium hypophosphates(NaH₂PO₂), hydrazine(N₂H₄), hydrochloride and sodium borohydride(NaBH₄) and heating the solution;

preparing a second solution including a polar solvent and a copper precursor and heating the solution; and

injecting the second solution into the first solution at a time and mixing each other.

Another aspect of the present invention may provide copper nanoparticles produced by the method.

Further, another aspect of the present invention may provide conductive ink including the copper nanoparticles produced by the method.

Hereinafter, the method of producing metal nanoparticles and the metal nanoparticles thus produced according to the present invention will be described in detail, taken in conjunction with the accompanying drawings.

One aspect of the present invention may provide a method of producing metal nanoparticles, including:

preparing a first solution including a polar solvent, a dispersing agent and one or more reducing agents selected from the group consisting of sodium hypophosphates(NaH₂PO₂), hydrazine(N₂H₄), hydrochloride and sodium borohydride(NaBH₄) and heating the solution;

preparing a second solution including a polar solvent and a copper precursor and heating the solution; and

injecting the second solution into the first solution at a time and mixing each other.

In the present invention, an aqueous solution of copper salts (a second solution) is made from a copper precursor, heated to reaction temperature and then injected into an aqueous solution including a dispersing agent and a reducing agent (a first solution) at the same temperature as the reaction temperature through a hot injection at a time, which is different from the conventional wet reduction process. Using this method, the uniform nucleation could be induced within short time and thus small copper nanoparticles having a size of 20-50 nm can be manufactured in a water based solvent system.

Here, the solvent for preparing the first solution and the second solution may be a polar solvent including a polyol, water and an alcohol. The solvent may be at least one selected from the group consisting of ethylene glycol, diethylene glycol, triethyleneglycol, polyethylene glycol and the mixtures thereof, preferably ethylene glycol.

The reducing agent included in the first solution plays a role of reducing a copper ion in the solution to a copper and may be sodium hypophosphates. In an embodiment of the invention, sodium hypophosphates induced a stable reduction reaction and resulted in improvement in production yield of copper nanoparticles.

According to the present invention, 2 to 6 moles of the reducing agent may be used based to 1 mole of copper salts. When less than 2 moles of the reducing agent is used, complete reduction of copper ions is not accomplished. On the other hand, it is uneconomical and causes excess production of side products to add more than 6 moles of the reducing agent since it is an excess amount required in 100% reduction of copper ions.

The dispersing agent included in the first solution may be one or more compounds selected from the group consisting of PVP (Polyvinylpyrrolidone), CTAB (Cetyltrimethylammonium bromide), SDS (Sodium dodecyl sulfate) and Na-CMC (Sodium carboxymethyl cellulose), preferably PVP having molecular weight of 40,000 or more.

A polymeric dispersing agent, PVP can control the size and uniformity of the particles produced, prevente particles from coagulating in a water based solvent, and provide great dispersibility.

According to the present invention, 1 to 20 moles of the dispersing agent may be used based to 1 mole of copper salts. When less than 1 mole of the dispersing agent is used, it is difficult to produce nanoparticles of a uniform size since the effect of controlling copper nanoparticles is reduced. When more than 20 moles of the dispersing agent are used, it is difficult to react uniformly since an excess amount of the dispersing agent causes rising in viscosity and the resulting problem of agitation. Moreover, a great amount of solvent is required to remove by-products and residual organic compounds, which is uneconomical.

The copper precursor may be one or more water soluble copper salts selected from the group consisting of CuSO₄, CuCl₂, Cu(NO₃)₂ and (CH₃COO)₂Cu, preferably, CuSO₄. Here, the copper precursor may be included at the concentration of 0.001-1 mole in the second solution.

In the meantime, the first solution and the second solution prepared according to the method of the invention may be heated to and maintained at 70 to 120° C. When it is over 120° C., the stability of the solution is reduced and the particles being produced are not uniform since the subsequent reaction progresses too fast. When it is below 70° C., the reduction reaction does not occur properly.

In the injection step, the second solution heated is injected into the first solution heated through a hot injection, and copper nanoparticles of 20-50 nm are produced. In this step, additional heating process is not required. The reaction time may be 2 to 10 minutes. When it is shorter than 2 minutes, the reduction reaction is not achieved enough, and when it is longer than 10 minutes, it is difficult to control the size of particles produced uniformly due to overgrowth of a particle.

When the reaction completes, it may be stopped by cooling quickly using cold distilled water to prevent overgrowth of particles, and the copper particles produced can be separated using a centrifuge. Then, the copper nanoparticles separated may be washed with acetone and distilled water to remove by-products and remaining organic compounds and dried at 50° C. for 3 hours in a vacuum drier.

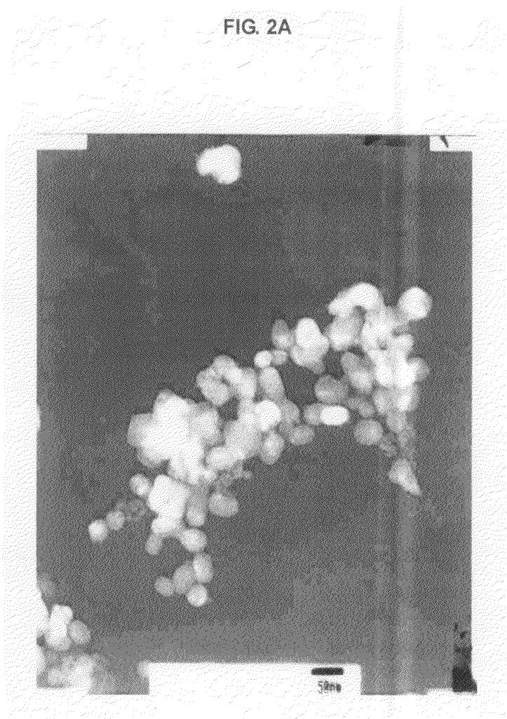

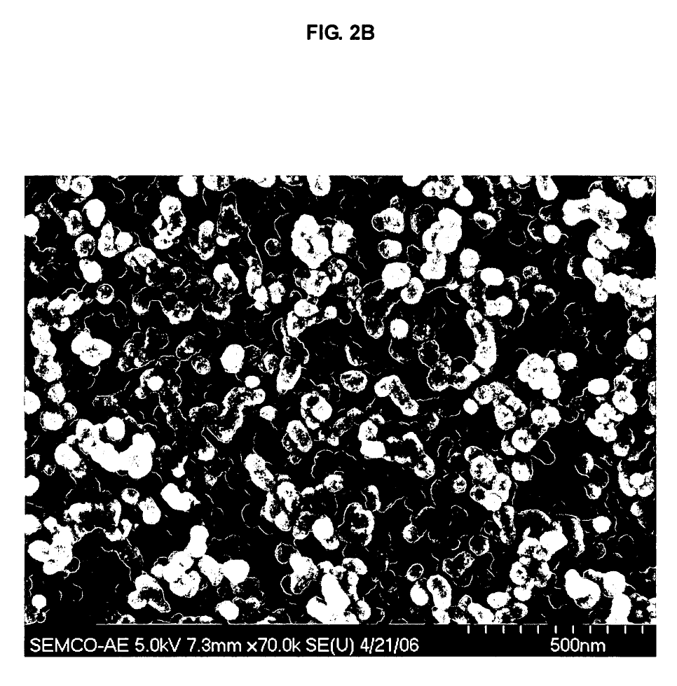

As shown in FIGS. 2a and 2b, TEM and SEM analyses show that particles of 20-50 nm having a uniform size and sphere form were produced according to the method of the invention.

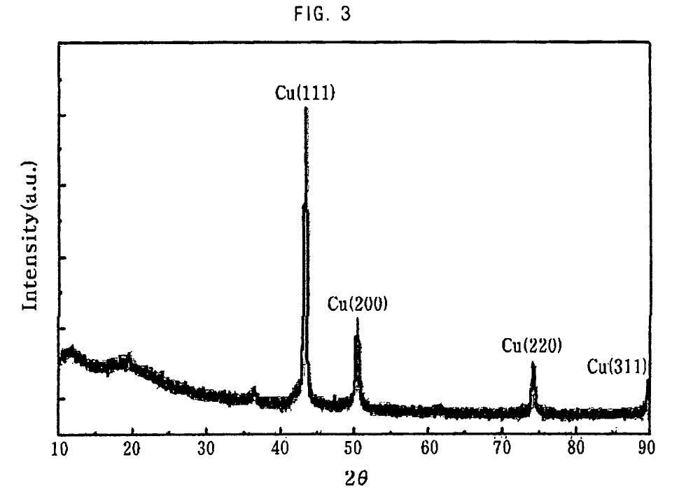

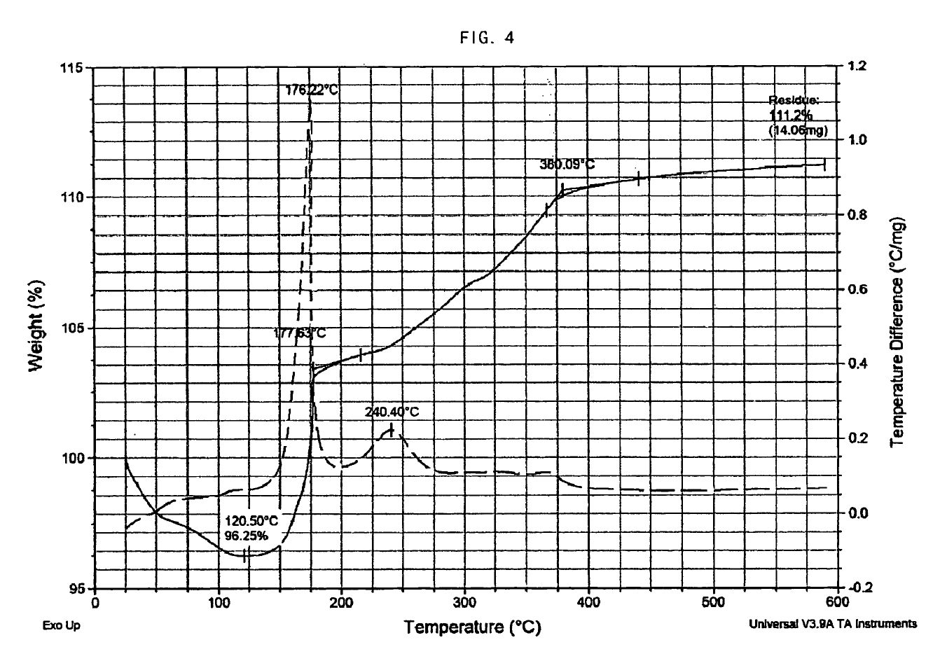

As shown in FIGS. 3 and 4, XRD analysis shows that the image of pure copper crystalline without the image of impurities and oxides was generated (Refer to FIG. 3). Further, thermogravimetric analysis (TGA) shows that the organic content was about 4% (Refer to FIG. 4).

Another aspect of the present invention may provide copper nanoparticles and conductive ink including the copper nanoparticles produced according to the invention.

That is, the copper particles of nano-size manufactured by the method according to the present invention can be dispersed in proper dispersion solution and then used in manufacturing conductive nano ink. Thereafter, the nano ink can be used in forming a metal pattern on a substrate or various electronic parts using an ink jet technology.

Recently, demands for a metal patterning of a thin film through ink jet or microwiring formation on a substrate have been increased according to a tendency of miniaturization and high densification of electronic parts.

In order to implement this, it is required that a conductive ink should be made from copper particles of nano-size which shows an excellent dispersibility, a uniform shape and a narrow distribution of particle size.

The present invention provides a method of producing nanoparticles massively meeting the requirements as well as being simple and economical. Therefore, copper nanoparticles and a conductive ink including the copper nanoparticles produced by the method is included within the scope of the present invention.

Hereinafter, the present invention is described in further detail by example. The following examples are intended to further illustrate the present invention without limiting its scope.

### EXAMPLE 1

### Production of Copper Nanoparticles

0.2 mole of sodium hypophosphates and 1 mole of PVP were mixed with and dissolved into 400 ml of ethylene glycol in a beaker with an agitator to prepare a first solution, and heated to 90° C. 0.1 mole of a copper sulfate was dissolved into 100 ml of ethylene glycol to prepare a second solution and heated to 90° C. The second solution was injected into the first solution of 90° C. at a time and the resulting solution was strongly mixed with an agitator. After the solution turned into a dark brown by a reduction reaction, cold distilled water was added, cooled quickly and centrifuged to obtain copper nanoparticles of a dark brown color. Then, the particles obtained were washed with acetone and distilled water 3 times and dried for 3 hours in a vacuum drier at 50° C. to recover finally 12 g of copper nanoparticles.

### EXAMPLE 2

### Production of Copper Nanoparticles

1.6 mole of sodium hypophosphates and 4 mole of PVP were mixed with and dissolved into 900 ml of ethylene glycol in a beaker with an agitator to prepare a first solution, and heated to 90° C. 0.4 mole of a copper sulfate was dissolved into 100 ml of ethylene glycol to prepare a second solution and heated to 90° C. The second solution was injected into the first solution at 90° C. at a time and the resulting solution was strongly mixed with an agitator. After the solution turned into a dark brown by a reduction reaction, cold distilled water was added, cooled quickly and centrifuged to obtain copper nanoparticles of a dark brown color. Then, the particles obtained were washed with acetone and distilled water 3 times and dried for 3 hours in a vacuum drier at 50° C. to finally recover 26 g of copper nanoparticles.

It will be understood that various details of the presently disclosed subject matter can be changed without departing from the scope of the presently disclosed subject matter. Furthermore, the foregoing description is for the purpose of illustration only, and not for the purpose of limitation.

### INDUSTRIAL APPLICABILITY

As described above, according to the present invention, copper nanoparticles powder which are fine and uniform can be produced simply, and thus the method is useful in mass production of copper nanoparticles.

What is claimed is:

1. A method of producing metal nanoparticles, comprising:
preparing a first solution including a polar solvent, a dispersing agent and one or more reducing agents selected from the group consisting of sodium hypophosphates(NaH₂PO₂), hydrazine(N₂H₄), hydrochloride and sodium borohydride(NaBH₄) and heating the solution;
preparing a second solution including a polar solvent and a copper precursor and heating the solution; and
injecting the second solution into the first solution at a time and mixing each other.

2. The method of claim 1, wherein the polar solvent is one or more selected from the group consisting of a polyol, water and an alcohol.

3. The method of claim 2, wherein the polyol is one or more selected from the group consisting of ethylene glycol, diethylene glycol, triethylene glycol, polyethylene glycol and the mixtures thereof.

4. The method of claim 1, wherein 2 to 6 moles of the reducing agent are included in the first solution based to 1 mole of the copper precursor.

5. The method of claim 1, wherein the dispersing agent is one or more selected from the group consisting of polyvinylpyrrolidone (PVP), cetyltrimethylammonium bromide (CTAB), sodium dodecyl sulfate (SDS) and sodium carboxymethyl cellulose (Na-CMC).

6. The method of claim 1, wherein 1 to 20 moles of the dispersing agent are included in the first solution based to 1 mole of the copper precursor.

7. The method of claim 1, wherein the copper precursor is one or more selected from the group consisting of CuSO₄, CuCl₂, Cu(NO₃)₂ and (CH₃COO)₂Cu.

8. The method of claim 1, wherein the copper precursor is included in the second solution at the concentration of 0.001 to 1 mole.

9. The method of claim 1, wherein the heating temperature is 70 to 120°.

10. The method of claim 1, wherein the injecting and mixing step is performed for 2 to 10 minutes.

11. Copper nanoparticles, produced by a method comprising: preparing a first solution including a polar solvent, a dispersing agent and one or more reducing agents selected from the group consisting of sodium hypophosphates(NaH₂PO₂), hydrazine(N₂H₄), hydrochloride and sodium borohydride(NaBH₄) and heating the solution; preparing a second solution including a polar solvent and a copper precursor and heating the solution; and injecting the heated second solution into the heated first solution at a time and mixing each other.

12. Conductive ink including the copper nanoparticles of claim 11.
